(19) United States
(12) Patent Application Publication
(10) Pub. No.: US 2026/0031369 A1
(43) Pub. Date: Jan. 29, 2026

(54) FUEL CELL STACK

(71) Applicant: TOYOTA JIDOSHA KABUSHIKI KAISHA, Toyota-shi (JP)

(72) Inventors: Tohru ODA, Toyota-shi (JP); Kohei SAKURAI, Toyota-shi (JP); Megumi KAWAI, Okazaki-shi (JP)

(21) Appl. No.: 19/241,526

(22) Filed: Jun. 18, 2025

(30) Foreign Application Priority Data
Jul. 23, 2024 (JP) 2024-117711

(51) Int. Cl. H01M 8/0276; H01M 8/0282

(52) U.S. Cl. CPC H01M 8/0276; H01M 8/0282

(57) ABSTRACT

A fuel cell stack may include a cell part including fuel cells stacked in a stacking direction, wherein each fuel cell may include: a support frame supporting a membrane electrode and gas diffusion layer assembly; and a first separator and a second separator interposing the support frame therebetween in the stacking direction; and a sealing plate facing one of opposing end surfaces of the cell part in the stacking direction. Each fuel cell may further include through holes forming manifolds in the cell part. When viewed in the stacking direction, the sealing plate may be devoid of through holes in its area overlapping the manifolds formed in the cell part. The sealing plate may include a substrate, and at least one of a plurality of first separators and a plurality of second separators may include the same substrate except for presence of the through holes.

### REFERENCE TO RELATED APPLICATION

This application claims priority to Japanese Patent Application No. 2024-117711 filed on Jul. 23, 2024, the contents of which are hereby incorporated by reference into the present application.

### TECHNICAL FIELD

The disclosure herein relates to a fuel cell stack.

### BACKGROUND

A fuel cell stack includes a cell part having a plurality of fuel cell stacked in a stacking direction. Each of the fuel cells includes a support frame supporting a membrane electrode and gas diffusion layer assembly; and a pair of separators interposing the support frame therebetween in the stacking direction. A plurality of through holes are formed in each of the fuel cells. The through holes formed in adjacent fuel cells communicate with each other in the stacking direction. Thus, manifolds configured to allow a fuel gas, an oxidation gas, and a cooling medium to flow therein are formed in the cell part. A sealing plate is located to face one of opposing end surfaces of the cell part in the stacking direction. The sealing plate seals the manifolds at the one end surface of the cell part. Thus, the fuel gas, the oxidation gas, and the cooling medium can circulate back and forth in the stacking direction within the cell part. Japanese Patent Application Publication No. 2014-44937 and Japanese Patent Application Publication No. 2022-63506 describe examples of this type of fuel cell stacks.

### SUMMARY

There is a need to reduce the manufacturing cost of such fuel cell stacks. This disclosure herein provides a fuel cell stack that is manufactured at a low manufacturing cost.

A fuel cell stack disclosed herein may comprise a cell part comprising a plurality of fuel cells stacked in a stacking direction and a sealing plate facing one of opposing end surfaces of the cell part in the stacking direction. Each of the fuel cells may comprise a support frame supporting a membrane electrode and gas diffusion layer assembly; and a first separator and a second separator interposing the support frame therebetween in the stacking direction. Each of the fuel cells may further comprise a plurality of through holes that form manifolds in the cell part, and the manifolds may be configured to allow a fuel gas, an oxidation gas, and a cooling medium to flow therein. When viewed in the stacking direction, the sealing plate may be devoid of through holes in its area that overlaps the manifolds in the cell part. The sealing plate may comprise a substrate, and at least one of a plurality of first separators and a plurality of second separators may comprise the same substrate except for presence of the plurality of through holes.

In the fuel cell stack disclosed herein, the sealing plate and the separators comprise the same type of substrate. Therefore, the fuel cell stack disclosed herein can be manufactured with fewer types of components.

### BRIEF DESCRIPTION OF DRAWINGS

FIG. 1 schematically shows an exploded side view of a fuel cell stack.

FIG. 2 schematically shows an exploded view of a fuel cell.

FIG. 3 schematically shows a configuration of a gas distribution surface of an anode-side separator.

FIG. 4 schematically shows a configuration of a cooling medium distribution surface of the anode-side separator.

FIG. 5 schematically shows a configuration of a cooling medium distribution surface of a scaling plate.

### DETAILED DESCRIPTION

In an aspect disclosed herein, a fuel cell stack disclosed herein may comprise a cell part comprising a plurality of fuel cells stacked in a stacking direction and a sealing plate facing one of opposing end surfaces of the cell part in the stacking direction. Each of the fuel cells may comprise a support frame supporting a membrane electrode and gas diffusion layer assembly; and a first separator and a second separator interposing the support frame therebetween in the stacking direction. Each of the fuel cells may further comprise a plurality of through holes that form manifolds in the cell part, and the manifolds may be configured to allow a fuel gas, an oxidation gas, and a cooling medium to flow therein. When viewed in the stacking direction, the scaling plate may be devoid of through holes in its area that overlaps the manifolds in the cell part. The sealing plate may comprise a substrate, and at least one of a plurality of first separators and a plurality of second separators may comprise the same substrate except for presence of the plurality of through holes.

In an aspect of the fuel cell stack disclosed herein, the opposing end surfaces of the cell part may comprise a cathode-side end surface and an anode-side end surface. The sealing plate may face the cathode-side end surface of the cell part.

In an aspect of the fuel cell stack disclosed herein, the sealing plate may comprise a surface treatment film covering a surface of the substrate. The surface treatment film may cover at least a part of the surface of the substrate that faces the cathode-side end surface of the cell part. When viewed in the stacking direction, the surface treatment film may not cover an area that overlaps the manifolds in the cell part and may cover an area that overlaps the membrane electrode and gas diffusion layer assembly.

In an aspect of the fuel cell stack disclosed herein, the substrate may comprise a stainless steel substrate. The surface treatment film may comprise a titanium film.

In one aspect of the fuel cell stack disclosed herein, the sealing plate may be in contact with a separator located at one of the opposing end surfaces of the cell part.

Representative, non-limiting examples of the present disclosure will now be described in further detail with reference to the attached drawings. This detailed description is merely intended to teach a person of skill in the art further details for practicing preferred aspects of the present teachings and is not intended to limit the scope of the disclosure. Furthermore, each of the additional features and teachings disclosed below may be utilized separately or in conjunction with other features and teachings to provide improved fuel cell stacks, as well as methods for using and manufacturing the same.

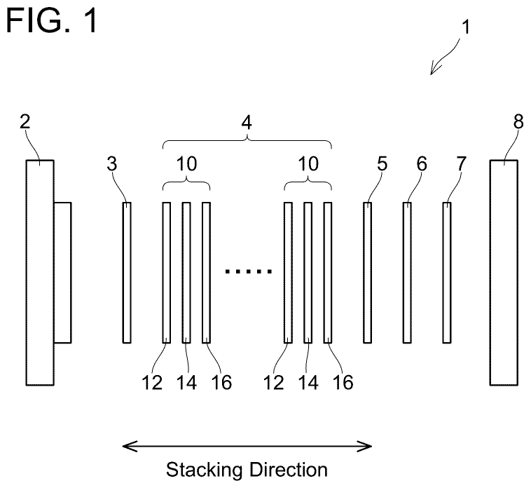

Referring to the drawings, a fuel cell stack, which is a power generating device that generates electric power by chemical reaction of a fuel gas and an oxidation gas, will be described. As shown in FIG. 1, a fuel cell stack 1 comprises an anode-side end plate 2, an anode-side terminal 3, a cell part 4 comprising a plurality of fuel cells 10 stacked in a stacking direction, a sealing plate 5, a cathode-side terminal 6, an insulator 7, and a cathode-side end plate 8. In the fuel cell stack 1 according to this embodiment, hydrogen gas may be used as the fuel gas and air may be used as the oxidation gas, although other gasses may be used alternatively.

The anode-side end plate 2 and the cathode-side end plate 8 are fastened to each other in the stacking direction by fasteners (not shown). Thus, various components between the anode-side end plate 2 and the cathode-side end plate 8 are held together between the anode-side end plate 2 and the cathode-side end plate 8.

The anode-side terminal 3 is a conductor that serves as a current collector for the cell part 4. The anode-side terminal 3 is electrically connected to an anode-side end face of the cell part 4. The cathode-side terminal 6 is also a conductor that serves as a current collector for the cell part 4. The cathode-side terminal 6 is electrically connected to a cathode-side end face of the cell part 4 via the sealing plate 5. The insulator 7 is located between the cathode-side terminal 6 and the cathode-side end plate 8. The insulator 7 is an insulator that electrically insulates the cathode-side terminal 6 from the cathode-side end plate 8.

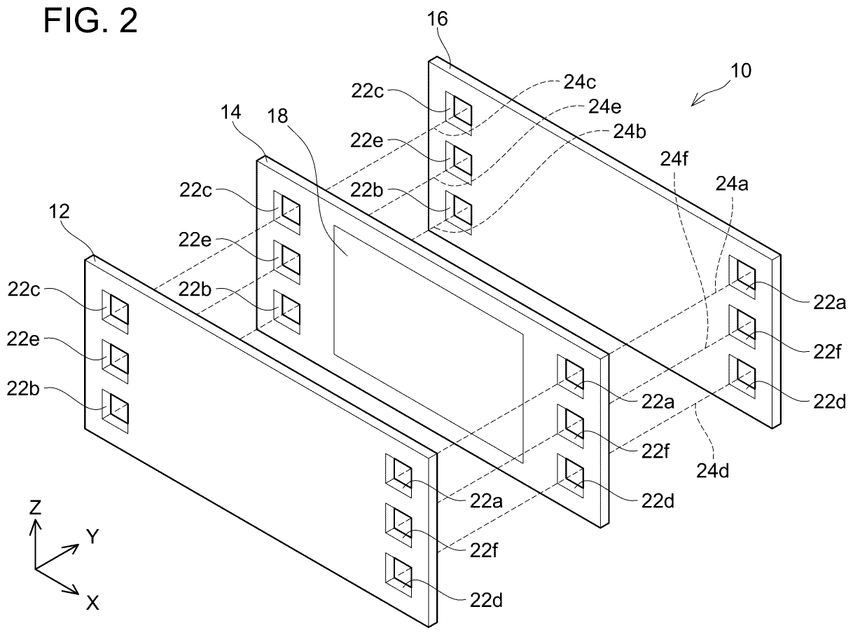

As shown in FIG. 2, each of the fuel cells 10 of the cell part 4 comprises an anode-side separator 12, a support frame 14, a cathode-side separator 16, and a membrane electrode and gas diffusion layer assembly (hereinafter referred to as “MEGA”) 18. The support frame 14 supports the MEGA 18 and is interposed between the anode-side separator 12 and the cathode-side separator 16.

Each of the pair of separators 12, 16 is constituted of a gas impermeable conductive material. Each of the pair of separators 12, 16 may comprise a metallic substrate. The metallic substrate may be, for example, a stainless steel substrate, although not limited thereto. Stainless steel may be an alloy of iron, chromium, and nickel. As described below, a surface treatment film may be formed on a part of the main surface of each metallic substrate to improve corrosion resistance and conductivity. Separators of the same shape may be used for the pair of separators 12 and 16, or separators of different shapes may be used for them. That is, the anode-side separator 12 and the cathode-side separator 16 may be identical components or different components.

The support frame 14 surrounds the perimeter of the MEGA 18 and supports the MEGA 18. The support frame 14 is constituted of an airtight and insulating resin material. The MEGA 18 is formed by stacking an anode-side gas diffusion layer, an anode electrode, an electrolyte membrane, a cathode electrode, and a cathode-side gas diffusion layer in this order, although this is not shown.

Six through holes 22a to 22f are formed in each of the pair of separators 12, 16 and the support frame 14. The six through holes 22a to 22f includes a first supply hole 22a, a first discharge hole 22b, a second supply hole 22c, a second discharge hole 22d, a third supply hole 22c, and a third discharge hole 22f. The first supply hole 22a may be a fuel gas supply hole, the first discharge hole 22b may be a fuel gas discharge hole, the second supply hole 22c may be an oxidation gas supply hole, the second discharge hole 22d may be an oxidation gas discharge hole, the third supply hole 22e may be a cooling medium supply hole, and the third discharge hole 22f may be a cooling medium discharge hole, although this may not be the case. Out of longitudinally opposing end portions (opposing in X direction in FIG. 2) of each of the separators 12, 16 and the support frame 14, three through holes 22a, 22d, 22f are located at one end portion and the other three through holes 22b, 22c, 22e are located at the other end portion.

In the cell part 4 of the fuel cell stack 1, the fuel cells 10 are arranged parallel to X and Z directions and stacked along Y direction. The Y direction corresponds to the stacking direction in FIG. 1. When the fuel cells 10 are stacked in the stacking direction, the first supply holes 22a formed in the pair of separators 12, 16 and the support frame 14 are connected together to form a first supply manifold 24a. Similarly, when the fuel cells 10 are stacked in the stacking direction, the second supply holes 22c form a second supply manifold 24c, the third supply holes 22e form a third supply manifold 24c, the first discharge holes 22b form a first discharge manifold 24b, the second discharge holes 22d form a second discharge manifold 24d, and the third discharge holes 22f form a third discharge manifold 24f. That is, six manifolds 24a to 24f are formed along the stacking direction in the cell part 4 of the fuel cell stack 1.

The fuel gas is supplied to each fuel cell 10 from the first supply manifold 24a. In each fuel cell 10, a fuel gas distribution channel is formed in a main surface of the anode-side separator 12 that faces the MEGA 18 among a pair of main surfaces of the anode-side separator 12 so that the fuel gas can flow between the anode-side separator 12 and the MEGA 18. After flowing through the fuel cells 10, the fuel gas is discharged to the outside of the fuel cell stack 1 through the first discharge manifold 24b.

The oxidation gas is supplied to each fuel cell 10 from the second supply manifold 24c. In each fuel cell 10, an oxidation gas distribution channel is formed in a main surface of the cathode-side separator 16 that faces the MEGA 18 among a pair of main surfaces of the cathode-side separator 16 so that the oxidation gas can flow between the cathode-side separator 16 and the MEGA 18. After flowing through the fuel cells 10, the oxidation gas is discharged to the outside of the fuel cell stack 1 through the second discharge manifold 24d.

The cooling medium is supplied to each fuel cell 10 from the third supply manifold 24c. In each fuel cell cell 10, a cooling medium distribution channel is formed in a main surface of the anode-side separator 12 that faces the cathode-side separator 16 and in a main surface of the cathode-side separator 16 that faces anode-side separator 12 so that the cooling medium can flow between the anode-side separator 12 and the cathode-side separator 16. After flowing through the fuel cells 10, the cooling medium is discharged to the outside of the fuel cell stack 1 through the third discharge manifold 24f.

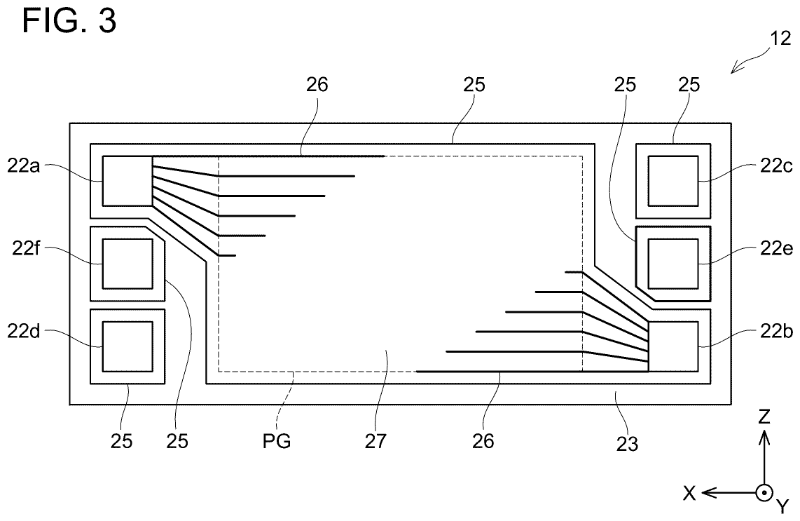

As shown in FIG. 3, a plurality of gas distribution grooves 26 are formed in one main surface of the anode-side separator 12 (i.e., the main surface facing the MEGA 18, hereinafter also referred to as “gas distribution surface”). The plurality of gas distribution grooves 26 extend from the first supply hole 22a through a power generation region PG to the first discharge hole 22b. The plurality of gas distribution grooves 26 may radially extend from the first supply hole 22a toward the power generation region PG, extend parallel to each other in the power generation region PG, and extend from the power generation region PG to the first discharge hole 22b in a converging manner, although this is merely an example. Thus, the fuel gas supplied from the first supply manifold 24a to each fuel cell 10 is guided from the first supply hole 22a along the gas distribution grooves 26 to the entire power generation region PG. After the power generation region PG, the fuel off-gas and produced water are guided along the gas distribution grooves 26 to the first discharge hole 22b into the first discharge manifold 24b. The fuel off-gas and produced water arc then discharged to the outside of the fuel cell stack 1 through the first discharge manifold 24b.

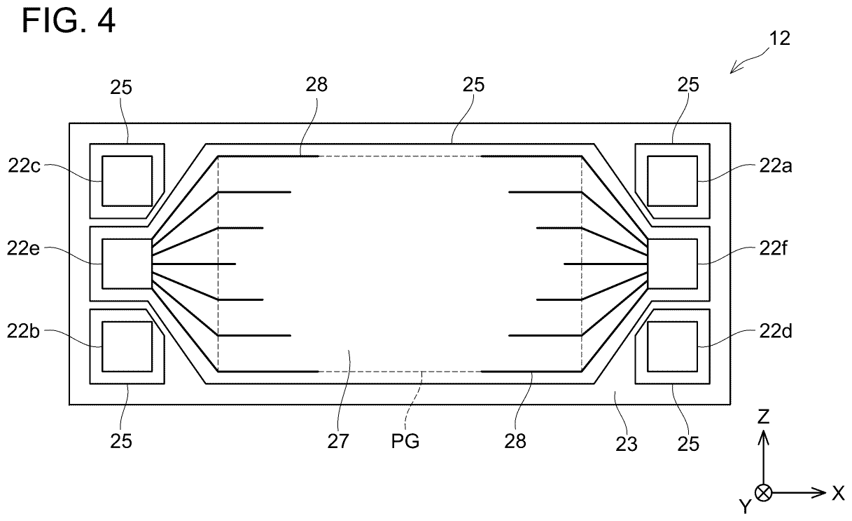

As shown in FIG. 4, a plurality of cooling medium distribution grooves 28 are formed in the other main surface of the anode-side separator 12 (i.e., the main surface facing the cathode-side separator 16 of the adjacent fuel cell 10, hereinafter also referred to as “cooling medium distribution surface”). The plurality of cooling medium distribution grooves 28 extend from the third supply hole 22e through the rear surface of the power generation region PG to the third discharge hole 22f. The plurality of cooling medium distribution grooves 28 may radially extend from the third supply hole 22e toward the power generation region PG, extend parallel to each other in the power generation region PG, and extend from the power generation region PG to the third discharge hole 22f in a converging manner, although this is merely an example. Thus, the cooling medium supplied from the third supply manifold 24c to each fuel cell 10 is guided from the third supply hole 22e along the cooling medium distribution grooves 28 to the entire rear surface of the power generation region PG. After flowing through the rear surface of the power generation region PG, the cooling medium is guided along the cooling medium distribution grooves 28 to the third discharge hole 22f into the third discharge manifold 24f. The cooling medium is then discharged to the outside of the fuel cell stack 1 through the third discharge manifold 24f.

As shown in FIGS. 3 and 4, each of the gas distribution surface and the cooling medium distribution surface of the anode-side separator 12 may include a gasket 25 to separate the respective distribution channels of the fuel gas, oxidation gas, and cooling medium. Furthermore, the power generation region PG on each of the gas distribution surface and the cooling medium distribution surface of the anode-side separator 12 includes a surface treatment film 27 on the surface of the metallic substrate 23. The surface treatment film 27 may be, for example, a film stack of a titanium film coating the surface of the metallic substrate 23 and a carbon film coating the surface of the titanium film, although this is merely an example. The titanium film is provided to improve the corrosion resistance of the fuel cell 10. The carbon film is provided to improve the conductivity of the fuel cell 10.

The depiction of the cathode-side separator 16 is omitted. Briefly, a plurality of gas distribution grooves are formed in a gas distribution surface of the cathode-side separator 16 and extend from the second supply hole 22c through a power generation region PG to the second discharge hole 22d, and a plurality of cooling medium distribution grooves are formed in a cooling medium distribution surface of the cathode-side separator 16 and extend from the third supply hole 22e through the rear surface of the power generation region PG to the third discharge hole 22. In case of the cathode-side separator 16 and the anode-side separator 12 being identical components, the cathode-side separator 16 is arranged in the opposite direction of the stacking direction with respect to the anode-side separator 12, so that the plurality of gas distribution grooves 26 (see FIG. 3) formed in the gas distribution surface can extend from the second supply hole 22c through the power generation region PG to the second discharge hole 22d, and the plurality of cooling medium distribution grooves 28 (see FIG. 4) formed in the cooling medium distribution surface can extend from the third supply hole 22e through the rear surface of the power generation region PG to the third discharge hole 22f.

Returning to FIG. 1, the sealing plate 5 is located between the cell part 4 and the cathode-side terminal 6. The sealing plate 5 is a conductor plate located to contact the cathode-side end surface of the cell part 4, i.e., the cooling medium distribution surface of the cathode-side separator 16. A separator, which is one of the anode-side separator 12 and the cathode-side separator 16, is used for the sealing plate 5. However, the separator used for the sealing plate 5 is different from the anode-side separator 12 and the cathode-side separator 16 in that the separator is devoid of the six through holes 22a to 22f.

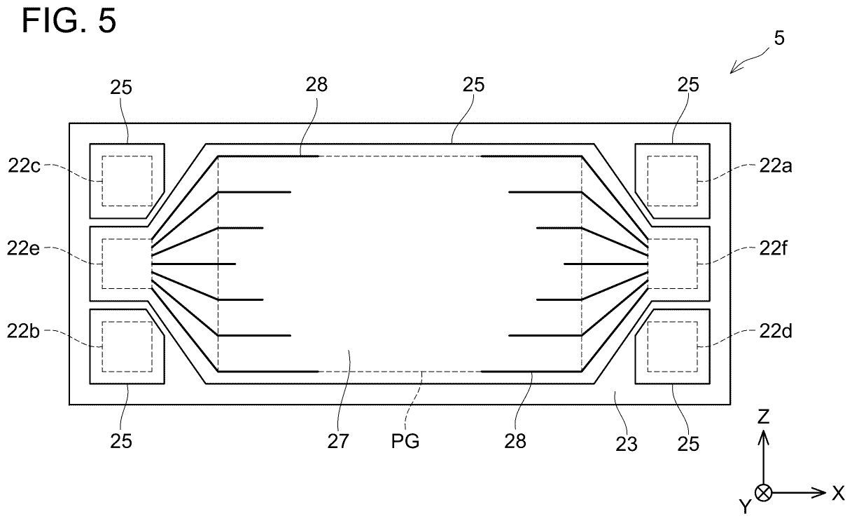

FIG. 5 shows a cooling medium distribution surface of the sealing plate 5. The positions of the six through holes 22a to 22f in the anode-side separator 12 and the cathode-side separator 16 are indicated by dashed lines. As shown in FIG. 5, the six through holes 22a to 22f are not formed in the sealing plate 5. Thus, the sealing plate 5 can seal each of the manifolds 24a to 24f in the cell part 4 at the cathode-side end surface of the cell part 4. This allows the fuel gas, the oxidation gas, and the cooling medium to circulate back and forth in the stacking direction within the cell part 4.

The sealing plate 5 is manufactured by omitting a step of forming the six through holes 22a to 22f in the metal substrate 23 from the process of manufacturing the anode-side separator 12 and the cathode-side separator 16. More specifically, the manufacturing method of the anode-side separator 12 and the cathode-side separator 16 includes a step of pressing the metallic substrate 23 to form the plurality of gas distribution grooves 26 and the plurality of cooling medium distribution grooves 25, a step of punching the metallic substrate 23 to form the six through holes 22a to 22f, and a step of forming the surface treatment film 27 on the power generation region PG within the surface of the metallic substrate 23. The sealing plate 5 may be manufactured by this manufacturing method without the punching step. Thus, the metallic substrate of the sealing plate 5 is identical to the metallic substrate 23 of the anode-side separator 12 or the cathode-side separator 16, except for the presence of the six through holes 22a to 22f. Therefore, it can be said that the fuel cell stack 1 comprises a structure that is manufactured with reduced types of components and can be manufactured at a low manufacturing cost. The sealing plate 5 may comprise a metallic substrate 23 manufactured without the punching step and the coating step.

Within the cooling medium distribution surface of the metallic substrate 23 of the sealing plate 5, the surface treatment film 27 is present within the power generation region PG, but absent within a manifold sealing portions, which is the areas corresponding to the positions of the six through holes 22a to 22f (the areas enclosed by the dashed lines in FIG. 5). Here, a comparative case is considered where the surface treatment film 27 is formed over the entire cooling medium distribution surface of the metallic substrate 23 of the sealing plate 5. The sealing plate 5 is located in contact with the cathode-side end surface of the cell part 4 among the opposing end surfaces of the cell part 4 in the stacking direction. When the cell part 4 generates electric power, a large voltage which is equivalent to the voltage generated by the entire cell part 4 is applied to the manifold sealing portions of the sealing plate 5 via liquids flowing through the manifolds (e.g., cooling water, produced water). Typically, defects exist in the surface treatment film 27. Therefore, if the surface treatment film 27 were present in the manifold sealing portions, localized corrosion would progress starting from the defects, leading to formation of corrosion holes in the sealing plate 5. In contrast, in the sealing plate 5 of this embodiment, the surface treatment film 27 is absent in the manifold sealing portions. Therefore, in the sealing plate 5 of this embodiment, high-speed corrosion starting from defects does not occur, and thus the reliability degradation due to corrosion can be suppressed.

While specific examples of the present disclosure have been described above in detail, these examples are merely illustrative and place no limitation on the scope of the patent claims. The technology described in the patent claims also encompasses various changes and modifications to the specific examples described above. The technical elements explained in the present description or drawings provide technical utility either independently or through various combinations. The present disclosure is not limited to the combinations described at the time the claims are filed. Further, the purpose of the examples illustrated by the present description or drawings is to satisfy multiple objectives simultaneously, and satisfying any one of those objectives gives technical utility to the present disclosure.

What is claimed is:

1. A fuel cell stack comprising:
a cell part comprising a plurality of fuel cells stacked in a stacking direction, wherein each of the fuel cells comprises: a support frame supporting a membrane electrode and gas diffusion layer assembly; and a first separator and a second separator interposing the support frame therebetween in the stacking direction; and
a sealing plate facing one of opposing end surfaces of the cell part in the stacking direction,
wherein
each of the fuel cells further comprises a plurality of through holes that form manifolds in the cell part, and the manifolds are configured to allow a fuel gas, an oxidation gas, and a cooling medium to flow therein,
when viewed in the stacking direction, the sealing plate is devoid of through holes in its area that overlaps the manifolds in the cell part,
the sealing plate comprises a substrate, and
at least one of a plurality of first separators and a plurality of second separators comprises the same substrate except for presence of the plurality of through holes.

2. The fuel cell stack according to claim 1, wherein
the opposing end surfaces of the cell part comprise a cathode end surface and an anode-side end surface, and
the sealing plate faces the cathode-side end surface of the cell part.

3. The fuel cell stack according to claim 2, wherein
the sealing plate comprises a surface treatment film covering a surface of the substrate,
the surface treatment film covers at least a part of the surface of the substrate that faces the cathode-side end surface of the cell part, and
when viewed in the stacking direction, the surface treatment film does not cover an area that overlaps the manifolds in the cell part and covers an area that overlaps the membrane electrode and gas diffusion layer assembly.

4. The fuel cell stack according to claim 3, wherein
the substrate comprises a stainless steel substrate, and
the surface treatment film comprises a titanium film.

5. The fuel cell stack according to claim 1, wherein
the sealing plate is in contact with a separator located at one of the opposing end surfaces of the cell part.
